(19) United States
(12) Patent Application Publication
(10) Pub. No.: US 2001/0050263 A1
(43) Pub. Date: Dec. 13, 2001

(54) Vinyl lifting crane and method

(76) Inventor: Glen Dale Freeman, Van Buren, AR (US)

Correspondence Address: Glen Freeman, 3627 Beech Way, Van Buren, AR, 72956, US

(21) Appl. No.: 09/741,947

(22) Filed: Dec. 20, 2000

Related U.S. Application Data
(60) Provisional application No. 60/173,091, filed on Dec. 27, 1999.
(60) Provisional application No. 60/122,806, filed on Mar. 4, 1999.

(51) Int. Cl. B66C 23/18

(52) U.S. Cl. 212/179

(57) ABSTRACT

In accordance with one embodiment of the present invention, the vinyl lifting crane includes a portable, mobile aluminum jib crane with an attached nip roller drive system. The drive will feed a preferred flat rope between the rollers for traction to achieve two primary functions. One function will enable the hoist to climb itself up to a structure by a person securing one end of a preferably flat rope to a support beam for example, and allowing the rope to hang in a vertical manner. The crane will be attached to free end of flat rope and radio control may be used to command the nip rollers to feed the rope between said rollers, enabling the hoist to climb the rope. This will eliminate the need to carry the hoist when climbing up stairways, ladders etc. Once the crane has climbed the rope, it is releasable attached to the structure by inserting a male square tubing member into a female square member of the structure, for example. Also the crane can be inserted into a trolley for horizontal travel. The second function will feed a preferred flat rope through the nip drive system and enable the lifting of vinyl faces, materials, tools, props, etc. up to a billboard structure. Counter weighting can be applied when lifting vinyl faces for billboards because usually one advertisement is being uninstalled, while an updated ad will replace it. So the need exist to lift the updated ad to the billboard structure, while lowering at the same time the replaced advertisement. The present invention addresses a need in the billboard industry because the hoist will eliminate physically, by block and tackle, lifting the vinyl faces manually up to the billboards. OSHA standards will not allow workers to carry items which may impede climbing the ladders safely, therefore the need for the self climbing hoist is warranted and appreciated which prior art does not address.

### BACKGROUND OF THE INVENTION

The present invention is directed to a portable or mobile jib crane with components thereof, and or units, assemblies, or subsystems thereof. More particularly, the present invention concerns an improved hoist, lift or materials handling jib crane with components, assemblies, units or subsystems, especially adapted for use in connection with billboard signs, marquees, displays, and the like.

In the billboard industry the use for vinyl faces to create images on, is a growing trend. The installing of the vinyl faces requires manual lifting by way of block and tackle, or a boom truck may be used to lift or lower the vinyl faces. Prior art does not address an efficient or practical method for elevating or lowering the vinyl faces.

Webb (U.S. Pat. No. 5,072,962) discloses a portable load bearing winch which is releasable attached to a front or back of a vehicle hitch using a female square tubing member and a square male end for attachment to the vehicle.

Morrow (U.S. Pat. No. 5,901,864) discloses a kingpost type luffing crane which can be removed from a receiving socket for re-location purposes.

Thiermann, S R. (U.S. Pat. No. 5,690,240) discloses a portable crane assembly which can be coupled to and decoupled from a transport dolly.

Richardson (U.S. Pat. No. 5,042,208) discloses a detachable concrete wall finishing machine which is capable of lifting a finishing head and able to transport the finishing head in a horizonal fashion along a concrete wall.

Hence there is a need for a portable/mobile jib crane for the billboard industry. The industry may become less reliant to physically lifting vinyl faces up to the billboards, or using heavy lift trucks which may be a burden for hard to access places and the expense of running them.

### BRIEF SUMMARY OF THE INVENTION

In accordance with the present invention, a vinyl lifting crane is provided which addresses the drawbacks of prior art and which is relatively simple in construction, easy to operate and maintain. In accordance with one embodiment of the present invention, the vinyl lifting crane is especially adapted for use in connection with billboard signs and the like, more particularly for lifting and lowering two objects of the approximate same weight simultaneously, better known as counter weighting. In the billboard industry the practice of creating images on a vinyl surface is commonplace in the industry, the vinyl lifting crane will aid in the lifting of a vinyl face which is to be installed, and the lowering of the uninstalled vinyl simultaneously, creating a counter weighting effect. The vinyl lifting crane will possess two primary functions in order to successfully aid in installing vinyl faces. The vinyl lifter will be capable of climbing itself up to a billboard structure, jib, for example then once atop a billboard can change function to serve as a hoist. This hoist is releasable attached to a billboard structure via male and female square tubing mating members making it mobile for the multiple locations it will need to be used. The vinyl lifter has a battery powered motor which drives a nip roller, in conjunction with the drive roller is a plurality of idler rollers. When a flat rope is threaded through these rollers traction of the rope occurs. This flat rope when attached atop a billboard will hang down or can be attached to an anchor point on the ground. The vinyl lifter will climb or descend the flat strap by method of traction from the nip rollers. Once the vinyl lifter is installed, it may be commanded by an infra red remote unit to drive the nip rollers which in turn will cause the flat rope move in a direction desired to lift one vinyl from the ground to atop the billboard while in turn lowering the uninstalled vinyl face to its destination on the ground, then the lowered vinyl may be loaded into a pick up truck for example. The vinyl installer will save money, time and be much more efficient than the present method of physically lifting the vinyls by way of block and tackle. Another method entails the use of boom trucks which may be expensive to operate and may not be able to get to hard to access places. The method of installing the vinyl with a boom truck includes the boom lifting a vinyl up to a billboard sign, attaching one end of the vinyl to the billboard then as the boom swings left to right will unroll the vinyl. The vinyl installer will possess horizontal movement by means of a trolley which has a female square tubing member to receive the male square tubing member of the vinyl installer. The vinyl lifter will unroll a vinyl face by manually pushing the trolley along a rail which is located in the back of the billboard sign. The mentioned drawbacks related to the current method of installing vinyl faces is apparent and warrants the introduction of a mobile or transportable, self climbing jib crane.

The principle object of the present invention is the provision of a hoist and method involving a hoist which is relatively simple in construction, easy to install, easy to operate, and easy to maintain.

Another object of the present invention is the provision of an improved mobile hoist and method including a transportable jib crane with its attached drive components.

A further object of the present invention is the provision of a self contained, battery powered motor drive system, for a jib crane.

Another object of the present invention is the provision of a self-contained, self propelled, transportable mobile jib crane.

Other objects and further scope of the applicability of the present invention will become apparent from the detailed description to follow, taken in conjunction with its accompanying drawings wherein like parts are designated by like reference numerals.

### BRIEF DESCRIPTION OF THE DRAWINGS

FIG. 1 A perspective view of a Vinyl Lifting Crane.

FIG. 2 A perspective view of drive embodiment for a Vinyl Lifting Crane.

FIG. 3 A side view for a Vinyl Lifting Crane.

FIG. 4 A side view for a ball device to actuate shut-off limit switch.

FIG. 5 A perspective view for a Vinyl Lifting Crane, including velcro material of respective flat rope(s).

FIG. 6 A perspective view for a Vinyl lifting Crane engaging a female member of a trolley, and disclosing rail for which trolley travels horizontally on billboard structure.

FIG. 7 A side view for a Vinyl Lifting Crane climbing itself upto a structure.

FIG. 8 Trolley with included female member for the recieving of Vinyl Lifting Crane's male supporting member.

FIG. 9 A perspective view for a Vinyl Lifting Crane including two corresponding drive units for improved torque efficiency.

FIG. 10 A perspective view for a Vinyl Lifting Crane installed into jib.

### DETAILED DESCRIPTION OF THE INVENTION

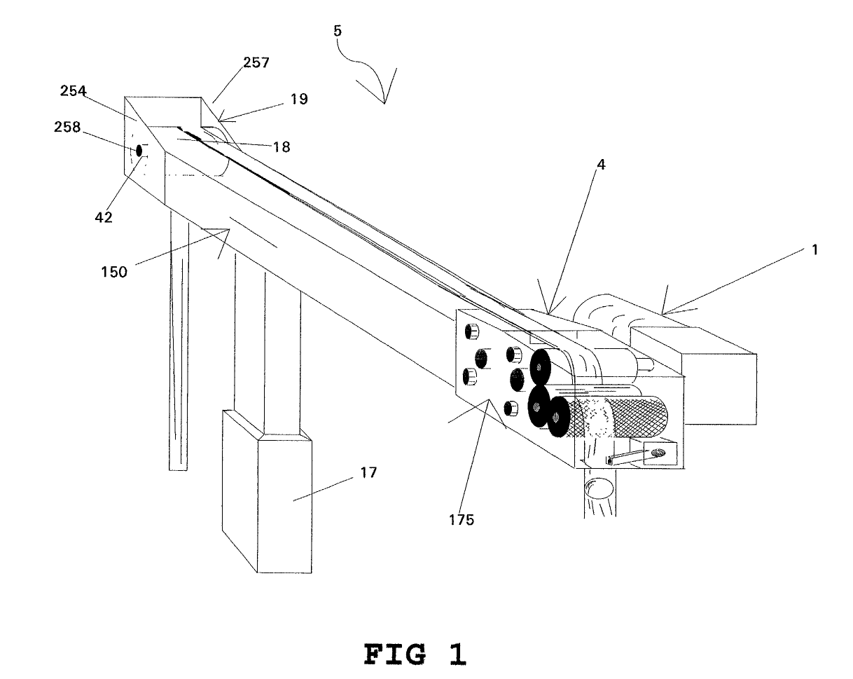

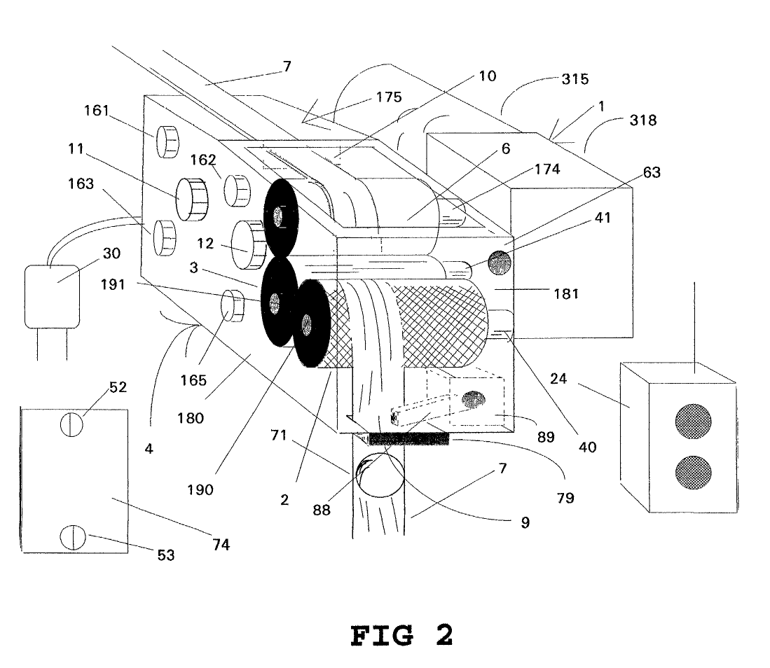

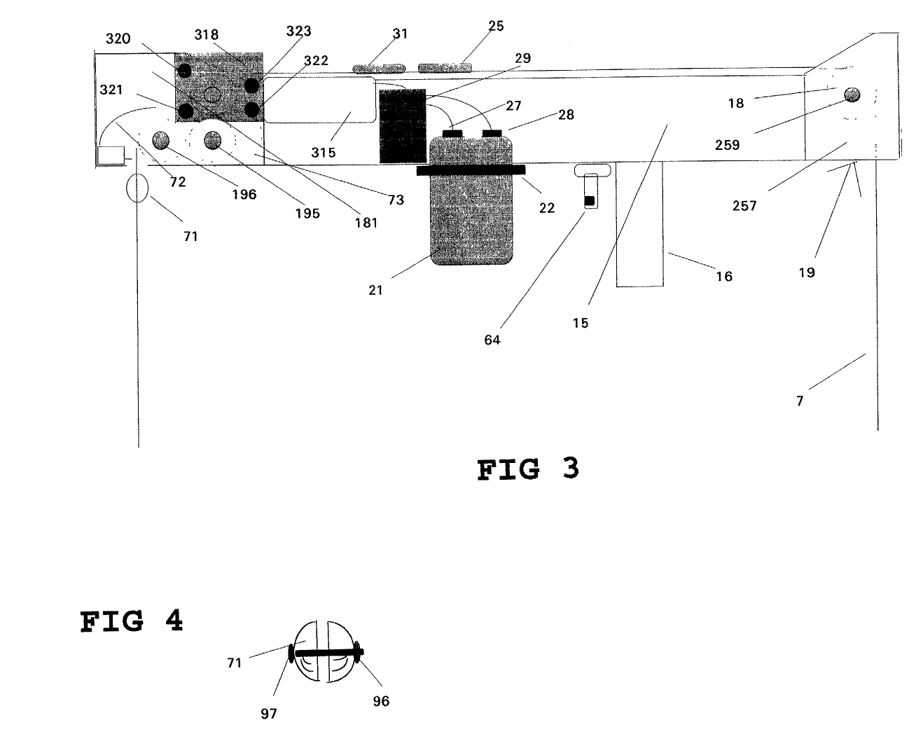

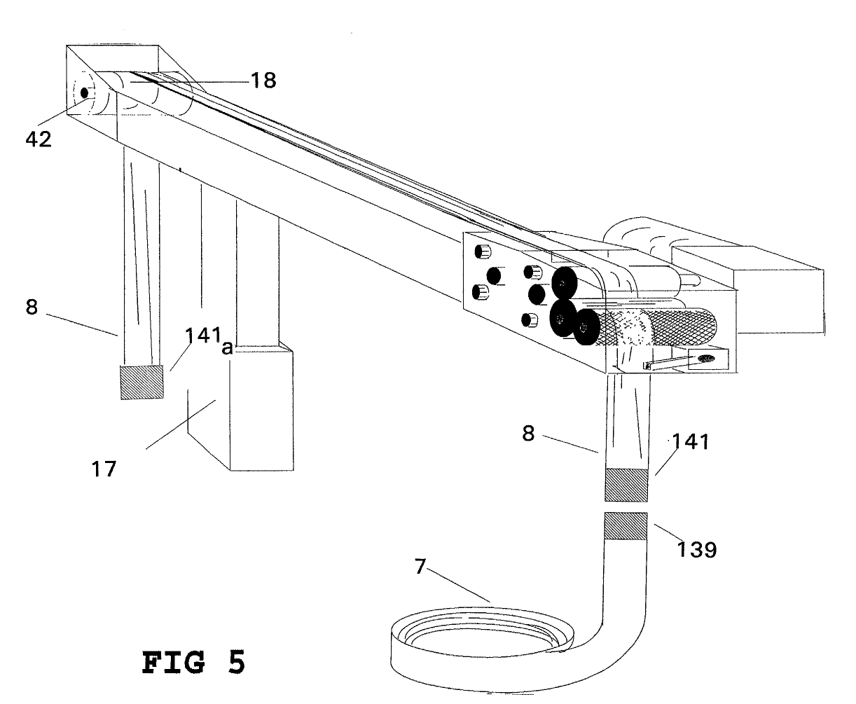

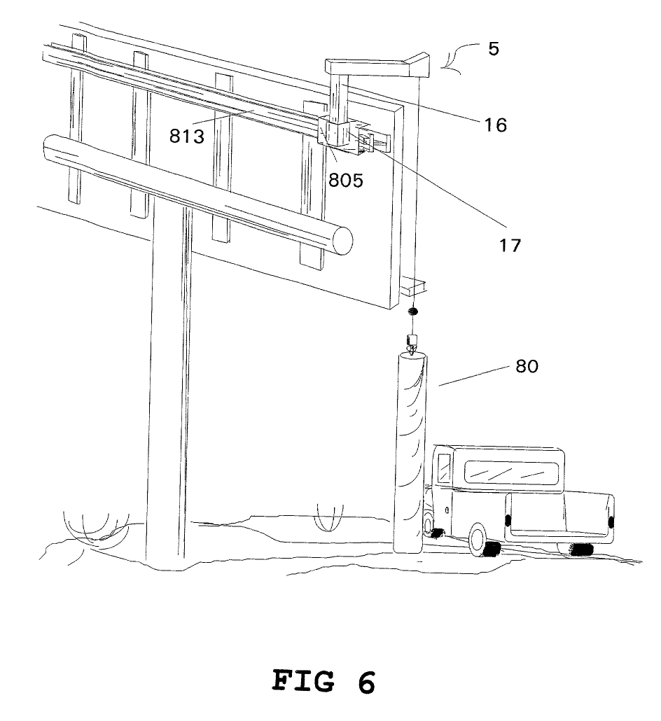

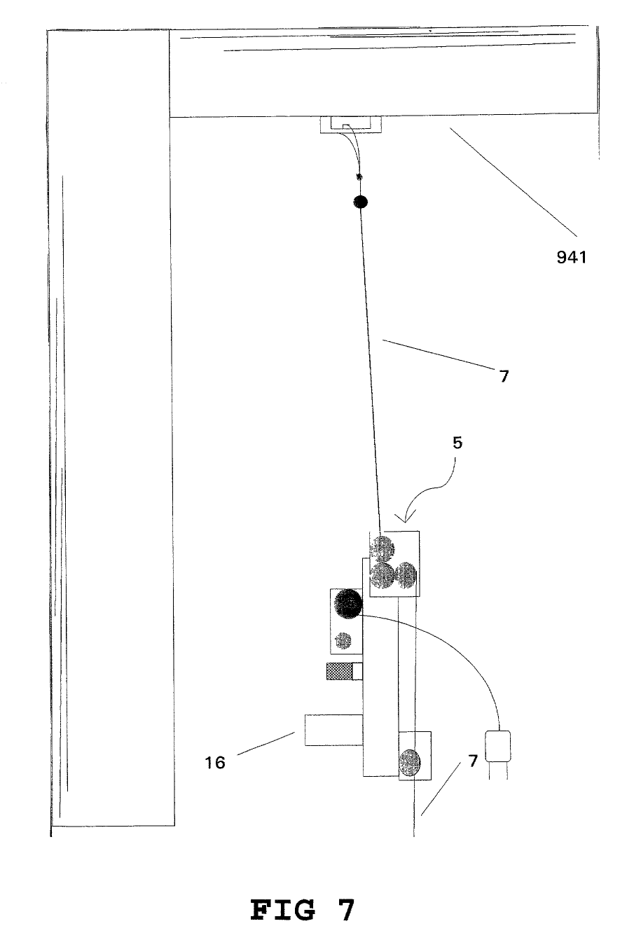

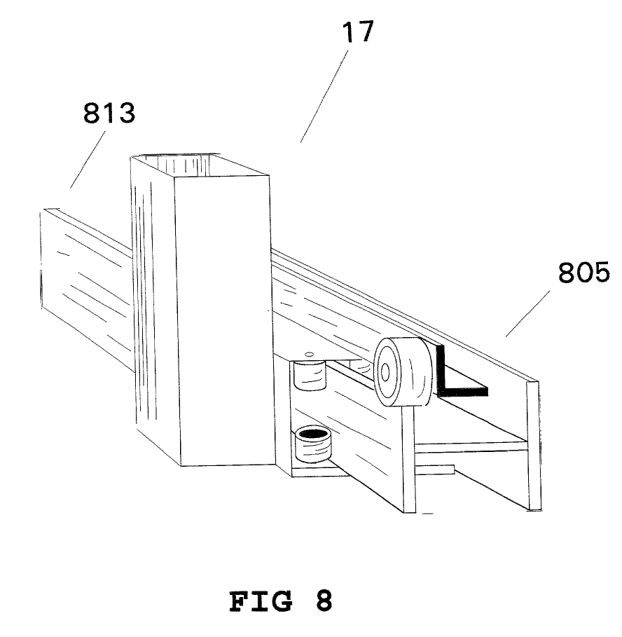

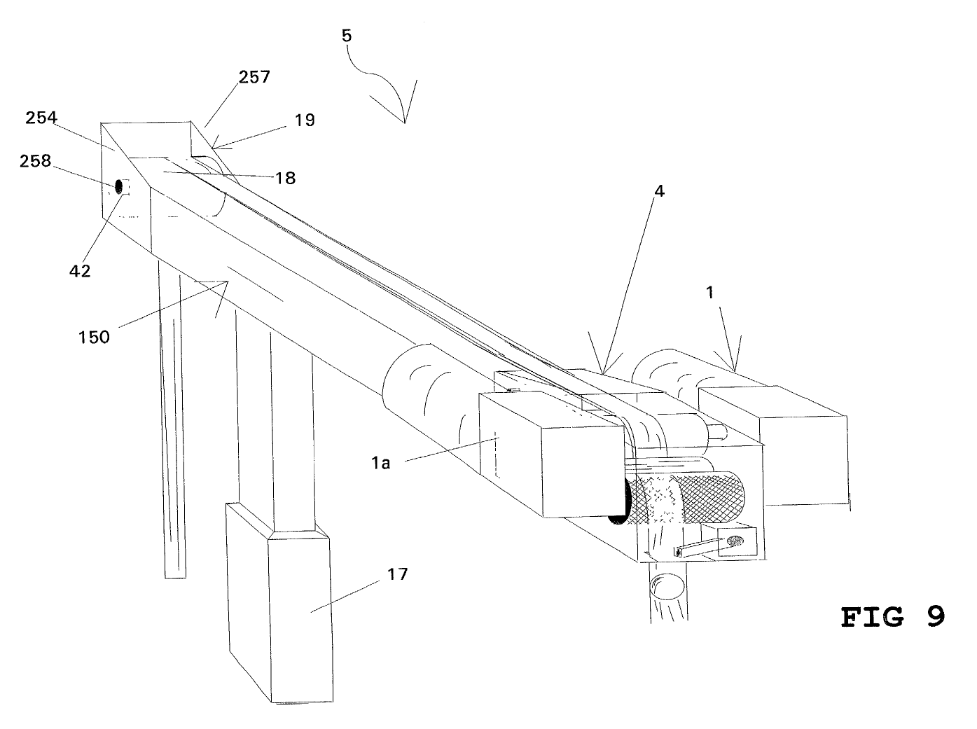

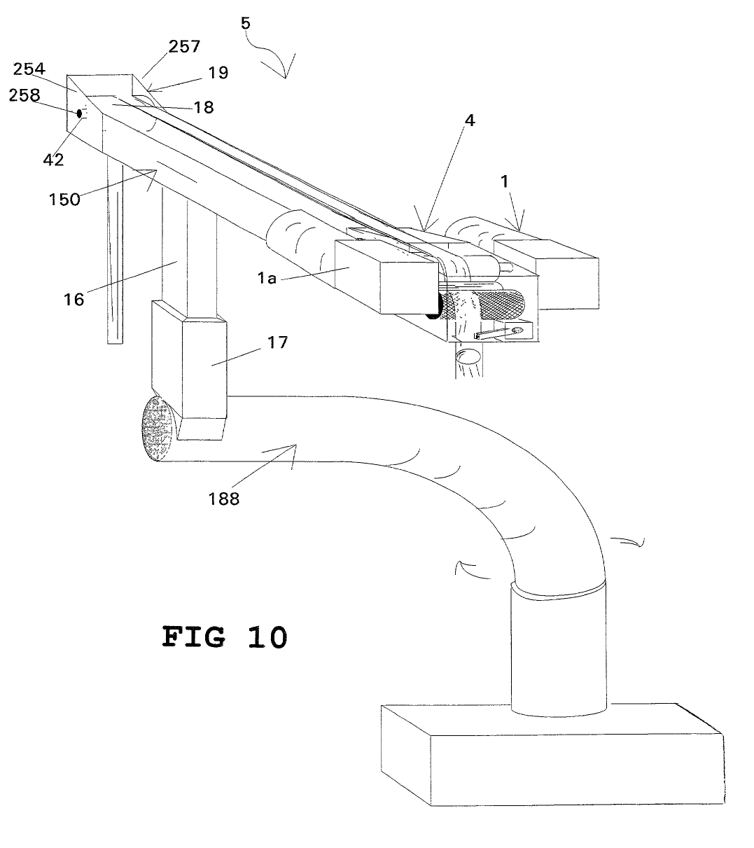

In accordance with one embodiment of the present invention the vinyl lifting crane designated as (5) includes an elongate square tubing member (15) attached to vertical member (16) to form the sub-frame (150) (see FIGS. 1, 2 & 3). The drive trane (1) which includes the drive motor (315) and gear reducer (318) will mount to member (175) via bolts (320), (321), (322), and (323). Drive roller (6) will be installed securely onto drive shaft (174) and idler roller (2) will rotate freely around shaft (40) and shaft (40) will extend between plates (180) and (181) will be attached to plates (180) and (181) via bolts (190) and (196). Bolts (190) and (196) will pass through their respective plates (180) and (181 ) and engage shaft (40) which will have a threaded core to enable tightening of the bolts. Idler roller (3) will rotate freely around shaft (41) and shaft (41) also will extend between plates (180) and (181) and be secured to plates (180) and (181) via bolts (195) and (191). It is conceived that shafts (40) and (41) can be secured with keepers (not shown). This drive system which includes drive motor (315), gearbox reducer (318), mounting member (175), and a plurality of rollers will be designated as drive embodiment (4) which can be releasable attached to member (15) via set screws (11) and (12) or could be attached rigidly by bolts (161), (162), (163), and (165). On one end of member (15) will be embodiment (19) which will include an idler roller (18) which will rotate around shaft (42) and shaft (42) will extend between plates (254) and (257) with bolts (258) and (259) to pass through said plates into the shaft (42) which will have a threaded hollow core to enable tightening of bolts (258) and (259) (see FIGS. 1 & 3). Embodiment (19) will serve as a guide roller for flat rope (7). To provide power to drive motor (315) rechargeable battery (21) will be inserted into battery holder (22) which will result in the engagement of the battery (21) to contacts (27) and (28) transferring the energy of battery (21) to said drive motor. The battery (21) can be charged by method of a recharging system from a vehicle to include voltage regulator, alternator or can be charged by plugging receptacle (30) into a 110 v outlet. When receptacle (30) is plugged into an outlet, 110 v is applied to onboard battery charger (29) which will result in providing correct regulated power to battery (21) which may be 12 v, 18 v, or 24 v depending on the voltage requirements of the battery (21) and drive motor (315). The power to drive motor can be actuated via remote control (24) by signaling remote censor (63), or using bidirectional switch (64) which will control on and off position, forward and reverse for example, when pertaining to direction, (see FIGS. 2 & 3). When power is supplied to drive motor (315) and rpm is reduced at the gearbox (318) output shaft (174), will rotate roller (6). When crane (5) is to be used, jog button (25) is pressed and power is supplied to drive trane (1) causing rotation of roller (6) to receive crane rope (8) through access opening (9) of embodiment (175). Guide plates (72) and (73) will aid in the threading of crane rope (8) through rollers (2), (3), and (6) (see FIG. 3). Also to aid in threading of rope (8) plate (74) which can be detached if needed via removing bolts (52), and (53) will enable access to manually thread rope (8) between rollers (2) and (3) then to capture said rope and manually guide it to exit access opening (10), (see FIGS. 2 & 5). Rope (8) is to remain threaded into crane (5) and said rope may have velcro stripe(s) (141) and (141a) on both ends. Rope (7) will also have a velcro stripe (139) and has the purpose of sticking to velcro (141) of rope (8) (see FIG. 5). When the jog button (25) is pushed, this will cause the rotation of drive roller (6) which will result in rope (8) to move in a direction to cause rope (8) to be pulled into access opening (9) and to pass through rollers (2), (3), (6), then to exit embodiment (4) through access opening (10). With the flat rope (7) engaging the rollers (2), (3), and (6) of the crane (5) one end of flat rope (7) is tied to a structure, for example elevated atop a billboard sign, the crane (5) may be commanded to actuate drive trane (1) via remote control device (24) this will result in rollers (2), (3), and (6) to rotate, thus traction occurs with flatrope (7) applied to rollers (2), (3), and (6) of the crane (5) resulting in the rope (7) travel direction pulling into access opening (9). This will result in the crane (5) to climb itself up to the structure via flatrope (7), teflon stripe (79) will help protect the flat rope, (see FIGS. 2 & 7). Once arrived at the structure, crane (5), if not stopped by operator will shut off via safety switch (89). When ball (71) strikes switch arm (88) (see FIG. 2), ball (71) can be removed from flat rope if desired by detaching nut (96) from threaded screw (97) disassembling ball (71) (see FIG. 4). Crane (5) can now be manually lifted into female square tubing member (17) which may be attached by weldments to trolley (805) (see FIG. 8), jib (188) (see FIG. 10) or directly to a desired structure. When crane (5) is properly installed into member (17) said crane can function as load bearing hoist. The flat rope (7) which is installed into access opening (9) will engage drive rollers (2), (3), and (6) then to exit from access opening (10) to extend the length of member (15) will rest across idler roller (18). This flat rope (7) can now become load bearing preferably by attaching one object on each end of said flatrope (7) to give counter weighting effect (see FIG. 1). This method may minimize wear and tear for drive trane (1). Also may reduce wear for a brake which the drive motor (315) may possess. When jog control (31) or (25) is pressed for desired direction (see FIG. 3), power is transferred to drive trane (1) resulting in the movement of load bearing flat rope (7) for the purpose of lowering one object while another object is being raised simultaneously (see FIG. 1). This command can also be achieved by remote control (24) (see FIG. 2). When trolley (805) is utilized, the vinyl (80) will travel horizontally across rail (813) which will give horizontal movement to crane (5). This will allow vinyl (80) to be unrolled by securing it to an end of a billboard then as the trolley (805) travels across rail (813) via manual power, the crane (5) will cause the vinyl (80) to unroll. Trolley (805) should remain on rail (813), (see FIGS. 6 & 8). It is concieved by those skilled in the art that different configurations for a self climbing crane can be used, for example, A female member may be attached to a structure, or a jib, to receive corresponding male member from multiple angles, horizontally or from bottom side of said jib for example. Said female and corresponding male members may be secured by a pin. Also a drum can be used by wrapping a rope around said drum several times, in conjunction with a guide on each end of the drum, when power is supplied to drive trane said drum will rotate, this will result in the traction of the rope to enable rope movement, and the guides to keep the rope from straying. The rope may need a grooved surface of the drum for stability.

Thus it will be appreciated that as a result of the present invention, a highly effective improved mobile jib crane is provided by which the principal objective, among others, is completely fulfilled. It is contemplated, and will be apparent to those skilled in the art from the preceding description and accompanying drawings, that modification and/or changes may be made in the illustrated embodiments without departure from the present invention. Accordingly, it is expressed intended that the forgoing description and accompanying drawings are illustrative of preferred embodiments only and not limiting, and that the true spirit and scope of the present invention be determined by reference to the appended claims.

I claim

1. A Vinyl Lifting Crane which is self-propelled, self contained and releasable attached to a billboard or sign structure for regular maintenance advertisement updating or changing vinyl faces, painted panels, or the like, comprising: A transportable or mobile crane, hoist or lift which is transported to and from the job site or billboard and which is adapted to climb or descend a rope, flat strapping material such as nylon, polypropylene or cotton. Said crane including a drive unit, a horizontally extending support member for load bearing means, and a male receiver member for proper placement of transportable hoist into a female receiver of a sign structure, jib or trolley.

2. A method of maintaining advertisement updating or changing an ad sign, billboard roadside sign, or the like, using the vinyl lifting crane of claim 1 including steps of: Transporting the portable crane to the job site, securing a preferred flat strap, or the like, to an elevated position of a sign structure, with a free end of the preferred flat rope contacting the ground. The drive unit of the portable or mobile crane is activated, resulting in rotation of the drive rollers creating traction of flat rope engaged for facilitating the substantially vertical movement of the transportable hoist, up or down the preferred flat strap. Upon arrival at the elevated position of the structure, said transportable crane can be manually placed into female member of structure, jib or trolley for application of hoisting and/or lowering vinyl faces, painted panels, or the like. After proper maintenance of advertisement updating changing of vinyl faces, painted panels, or the like, is complete, transportable crane, hoist, or lift is released from the female member of the structure, jib, or trolley to again engage flat rope for facilitating the substantial vertical movement, descending the flat rope to the ground level, said transportable crane, hoist or lift can be transported to next job site.

3. A transportable crane, hoist, or lift as recited in claim 1 which is adapted to engage a flat rope, strap, or the like, for facilitating the substantial vertical movement up or down said flat rope, strap, or the like.

4. A transportable hoist as recited in claim 1 which is releasable attached to a Jib of a sign structure with said jib of a sign comprising a female support member for facilitating proper support and placement of transportable crane, hoist or lift. Said jib further comprising elements capable of rotating said jib 360 degrees to facilitate necessary positioning for said transportable crane, hoist or lift.

5. A releasable attached transportable crane, hoist or lift as recited in claim 1 further comprising: A horizontal rail supporting a roller guide for facilitating substantial movement horizontally along the rail and including a receiver adapted to receive a support member of said transportable crane, hoist, or lift for detachably supporting a removable crane, hoist or lift.

6. A transportable crane, hoist or lift of claim 1 wherein said releasable attached crane is adapted to lift and/or lower vinyl faces, painted panels, or the like, via horizontally extending member with guiding elements comprising both ends.

7. A transportable crane, hoist, or lift as recited in claim 1 wherein transportable crane, hoist, or lift comprises: An electrical D.C. powered motor, a gear reducer and drive rollers for facilitating substantial movement of engaged flat rope, strap, or the like. Said electrical D.C. powered motor may be powered via rechargable battery.

8. A transportable crane, hoist, or lift as recited in claim 7 wherein transportable crane, hoist or lift comprises: A gasoline or propane powered combustible engine for facilitating movement for drive rollers of said crane.

9. A transportable crane, hoist, or lift as recited in claim 7 wherein said transportable crane, hoist, or lift includes two corresponding drive units for facilitating rotational movement of drive rollers for improvement of torque efficiency.

10. A transportable crane,hoist or lift as recited in claim 2 wherein said transportable crane, hoist or lift includes a flat strap engaged, including velcro material comprising both ends of said flat strap.

11. A transportable crane, hoist or lift as recited in claim 1 which is self propelled, self contained comprising: A male member for facilitating proper support of said crane, hoist or lift when installed into a female member of a structure, jib or trolley.

12. A transportable crane, hoist or lift wherein is self propelled, self contained including, a drive unit containing drive rollers engaging, a flat rope, strap, or the like. Said flat strap is attached atop a billboard structure (for example) via means of a support member, jib, boom, or the like, for facilitating substantial vertical movement for said engaged transportable crane, hoist or lift, up or down said flat strap, resulting in transportable crane, hoist or lift dependant upon said flat strap for support means. Upon activation of drive unit for transportable crane, hoist, or lift, climbing said flat strap will commence and transportable crane, hoist or lift will arrive atop the structure for releasable attachment to a support member of the billboard. The attachment means for said transportable crane, hoist or lift, preferrably will entail use of a male member secured to said transportable crane, hoist or lift, to be installed into a female member secured to support member of the billboard. Said female member may be attached to a boom, jib, trolley, or a metal support beam for example, of said billboard structure. After transportable crane, hoist, or lift is temporarily attached to billboard structure, said transportable crane is no longer dependant upon flat strap for support means, therefore, said flat rope, strap, or the like, is released from support member of the billboard structure, and may function as a hoisting strap for engaged transportable crane, hoist or lift to carry supplies up or down a billboard sign, for example.
